(19) United States
(12) Patent Application Publication
(10) Pub. No.: US 2025/0253361 A1
(43) Pub. Date: Aug. 7, 2025

(54) COOLING SYSTEM FOR FUEL CELL ONBOARD A VEHICLE INCLUDING AUXILIARY EVAPORATIVE COOLING

(71) Applicant: ZeroAvia Ltd., Palo Alto, CA (US)

(72) Inventors: Seied Masoud Ameli, Swindon (GB); Michael Patterson, Bath (GB); Matthew Graham Legg, Swindon (GB)

(73) Assignee: ZeroAvia Ltd., Palo Alto, CA (US)

(21) Appl. No.: 18/856,002

(22) PCT Filed: Apr. 29, 2022
(86) PCT No.: PCT/GB2022/051112

§ 371 Date: Oct. 10, 2024

(51) Int. Cl. H01M 8/04007; B64D 27/31; B64D 27/355; B64D 33/10; H01M 8/04029; H01M 8/0432; H01M 8/04746

(52) U.S. Cl. CPC H01M 8/04059; B64D 27/31; B64D 27/355; B64D 33/10; H01M 8/04029; H01M 8/04358; H01M 8/04768; H01M 2250/20

(57) ABSTRACT

A cooling system for a fuel cell onboard a vehicle includes a plenum, a coolant circuit, and a liquid-to-air heat exchanger. The plenum is configured to receive an airflow from an ambient environment. The coolant circuit is configured to circulate a coolant through the coolant circuit and through a portion of the fuel cell. The liquid-to-air heat exchanger includes a thermally conductive wall having a first side that at least partially defines an airflow channel in fluid communication with the plenum and an opposite second side that at least partially defines a coolant channel in fluid communication with the coolant circuit. The first side of the thermally conductive wall includes a porous wick. When a working fluid is introduced into the porous wick, the porous wick is configured to evaporatively cool the coolant flowing through the coolant channel by promoting evaporation of the working fluid therefrom.

### FIELD

The present disclosure relates to cooling systems for fuel cells onboard vehicles and, more particularly, to cooling systems for fuel cells that use ambient air as a heat-transfer medium.

### BACKGROUND AND SUMMARY

This section provides background information related to the present disclosure which is not necessarily prior art. This section provides a general summary of the disclosure and is not a comprehensive disclosure of its full scope or all of its features.

A fuel cell is an electrochemical cell that converts chemical energy into electrical energy by means of spontaneous electrochemical reduction-oxidation (redox) reactions. Fuel cells include an anode and a cathode separated by an ionically conductive electrolyte. During operation, a fuel (e.g., hydrogen) is supplied to the anode and an oxidant (e.g., oxygen or air) is supplied to the cathode. The fuel is oxidized at the anode, producing positively charged ions (e.g., hydrogen ions) and electrons. The positively charged ions travel through the electrolyte from the anode to the cathode, while the electrons simultaneously travel from the anode to the cathode outside the cell via an external circuit, which produces an electric current. The oxidant supplied to the cathode is reduced by the electrons arriving from the external circuit and combines with the positively charged ions to form water. The reaction between oxygen and hydrogen is exothermic, generating heat that needs to be removed from the fuel cell.

Fuel cells may be used as power sources for electric motors of electric vehicles and hybrid electric vehicles, including aircraft. In such applications, fuel cells are oftentimes arranged in stacks of multiple cells and connected in a series or parallel arrangement to achieve a desired power and output voltage. Cooling systems for fuel cell-powered vehicles oftentimes use an airflow generated during movement of the vehicle as a heat transfer medium. For example, an ambient airflow may be directed from outside the vehicle through an air intake of the vehicle and through one or more heat exchangers disposed within the vehicle. An airflow generated in this manner is oftentimes referred to as ram air and, when ram air is used as a cooling medium in a vehicle, the vehicle may experience increased drag, which may reduce the energy efficiency of the vehicle.

In fuel cell-powered aircraft, the power output demanded of the fuel cells—and the amount of waste heat generated by the fuel cells—is oftentimes greatest during take-off and climb. Waste heat generated during operation of powered aircraft may be dissipated by positioning an air-cooled heat exchanger in an ambient airflow path through the aircraft. Directing ambient air to flow through the aircraft (instead of around the aircraft) when the aircraft is moving creates drag, with the amount of drag experienced by the aircraft being proportional to the volume of ambient air directed through the aircraft (and through the heat exchanger). In practice, the volume of the air-cooled heat exchanger (and the volume of air directed through the heat exchanger) may be selected to accommodate the most demanding cooling requirements of the aircraft, which may occur when the aircraft is operating under high load conditions, e.g., during take-off and climb. However, sizing the heat exchanger in this way may cause the aircraft to experience an unnecessarily large amount of drag when the aircraft is operating under low load conditions, e.g., during cruise, when minimal waste heat dissipation is needed. In addition, when cooling requirements are low, the presence of an oversized heat exchanger onboard the aircraft adds unnecessary weight and bulk to the aircraft.

It may be desirable to develop a system that can be used to effectively remove waste heat from a fuel cell onboard a vehicle during high load events without increasing the amount of drag experienced by the vehicle when the vehicle is operating under normal or low load conditions.

A cooling system for a fuel cell onboard a vehicle is disclosed. The cooling system comprises a plenum, a coolant circuit, and a liquid-to-air heat exchanger. The plenum includes an inlet and an outlet in fluid communication with an ambient environment. The inlet of the plenum is configured to receive an airflow from the ambient environment. The coolant circuit is configured to circulate a coolant through the coolant circuit and through a portion of the fuel cell to transfer waste heat away from the fuel cell to the coolant. The liquid-to-air heat exchanger includes a thermally conductive wall having a first side and an opposite second side. The first side of the thermally conductive wall at least partially defines an airflow channel in fluid communication with the inlet and the outlet of the plenum. The second side of the thermally conductive wall at least partially defines a coolant channel in fluid communication with the coolant circuit. The first side of the thermally conductive wall includes a porous wick defining an interconnected network of open pores. When a working fluid is introduced into the interconnected network of open pores of the porous wick, the porous wick is configured to evaporatively cool the coolant flowing through the coolant channel by promoting evaporation of the working fluid from the interconnected network of open pores into the airflow flowing through the airflow channel.

When a working fluid is not present in the interconnected network of open pores of the porous wick, the porous wick may be configured to cool the coolant flowing through the coolant channel by promoting at least one of convective heat transfer and conductive heat transfer between the coolant flowing through the coolant channel and the airflow flowing through the airflow channel.

When the porous wick is in direct contact with a working fluid, the porous wick may be configured to distribute the working fluid throughout the interconnected network of open pores by capillary action.

The cooling system may comprise a metering device configured to control a flow of a working fluid to the porous wick.

In some embodiments, the metering device may comprise a control valve. The control valve may be moveable between an open position and a closed position. When the control valve is in the open position, working fluid may be introduced into the interconnected network of open pores of the porous wick. When the control valve is in the closed position, working fluid may be preventing from entering the interconnected network of open pores of the porous wick.

When the control valve is in the open position, working fluid may flow into the interconnected network of open pores of the porous wick by gravity or by capillary action.

In some embodiments, the metering device may comprise a pump. The pump may be configured to introduce a working fluid into the interconnected network of open pores of the porous wick.

The working fluid may be the same or different than the coolant. In embodiments here the working fluid is the same as the coolant, the metering device may be in fluid communication with the coolant circuit and may be configured to control a flow of the coolant to the porous wick.

The cooling system may comprise a working fluid reservoir in fluid communication with the metering device. The metering device may be configured to control a flow of a working fluid from the working fluid reservoir to the porous wick.

The cooling system may comprise a controller configured to control operation of the metering device such that (i) working fluid flows into the interconnected network of open pores of the porous wick when the vehicle is operating under high load conditions, and (ii) working fluid is prevented from flowing into the interconnected network of open pores of the porous wick when the vehicle is operating under low load conditions.

The cooling system may comprise a temperature sensor configured to sense a temperature of the coolant flowing through the coolant circuit and to communicate the temperature to the controller.

The cooling system may comprise a nozzle configured to spray a working fluid onto the porous wick or into the airflow flowing through the airflow channel upstream of the porous wick.

The liquid-to-air heat exchanger may be disposed within the plenum.

The cooling system may comprise a working fluid in fluid communication with the porous wick. The working fluid may comprise water.

The cooling system may comprise a third heat exchanger coupled to the fuel cell. The third heat exchanger may be configured to transfer heat from the fuel cell to the coolant circulating through the coolant circuit.

The fuel cell may comprise an anode configured to receive a hydrogen-containing reactant gas and to discharge a hydrogen-containing exhaust gas stream and a cathode configured to receive an oxygen-containing reactant gas and to discharge a water vapor-containing exhaust gas stream.

The inlet of the plenum may be configured to receive the airflow from the ambient environment when the vehicle is moving.

The cooling system may comprise a coolant header tank in fluid communication with the coolant circuit.

The vehicle may be an aircraft. In such case, the airflow may comprise ram air.

The plenum may be defined within a wing of the aircraft, and the liquid-to-air heat exchanger may be disposed within the plenum.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a process flow diagram of a cooling system for a fuel cell onboard a vehicle, the cooling system comprises a coolant circuit, a plenum in fluid communication with an ambient environment, and a liquid-to-air heat exchanger disposed within an ambient airflow path through the plenum.

FIG. 2 is a schematic depiction of an aircraft including a fuel cell onboard the aircraft.

FIG. 3 is a schematic cross-sectional view of the liquid-to-air heat exchanger of FIG. 1, the liquid-to-air heat exchanger including a thermally conductive barrier having a first side that at least partially defines an airflow channel in fluid communication with the plenum and an opposite second side that at least partially defines a coolant channel in fluid communication with the coolant circuit, wherein the first side of the thermally conductive barrier includes a porous wick and, when a working fluid is introduced into the porous wick, the porous wick is configured to evaporatively cool the coolant flowing through the coolant channel by promoting evaporation of the working fluid therefrom.

FIG. 4 is a schematic cross-sectional view of another liquid-to-air heat exchanger including multiple airflow channels and multiple coolant channels disposed between the airflow channels, wherein each of the coolant channels is physically separated from an adjacent airflow channel by a thermally conductive barrier including a porous wick.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

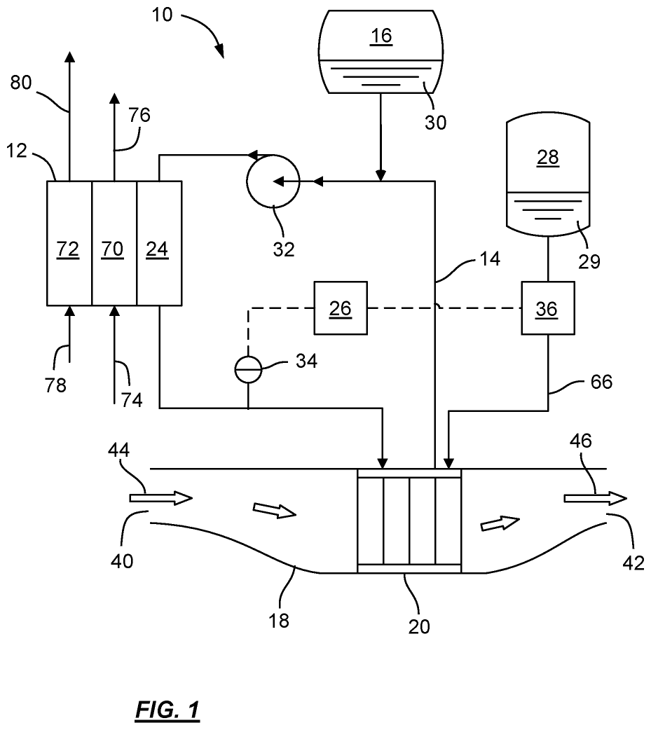

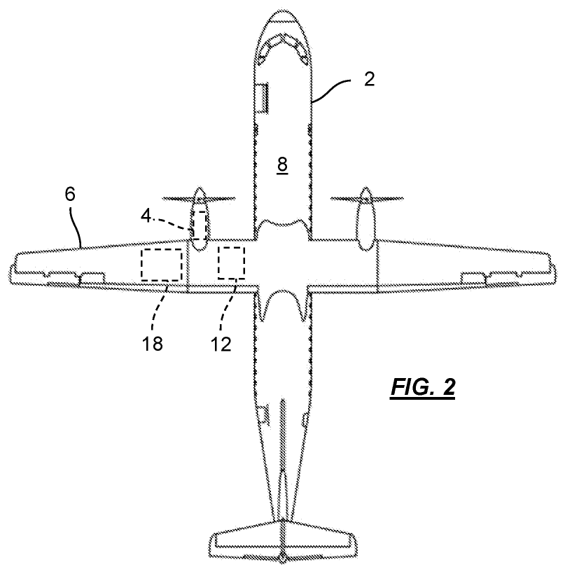

FIG. 1 depicts a process flow diagram of a cooling system 10 for a fuel cell 12 onboard a vehicle. As shown in FIG. 2, the fuel cell 12 may be located onboard an aircraft 2 that is powered at least in part by an electric motor 4. In some aspects, the fuel cell 12 may be disposed in a wing 6 of the aircraft 2. In some aspects, the fuel cell 12 may be located in a hull 8 of the aircraft 2 or in any other part of the aircraft 2.

The cooling system 10 may be configured to maintain the fuel cell 12 within an acceptable operating temperature range, for example, by transferring waste heat generated by the fuel cell 12 away from the fuel cell 12 to a cooling medium. The cooling system 10 may be configured to accommodate varying cooling requirements of the aircraft 2. To accomplish this, for example, the cooling system 10 may vary the amount of heat transferred away from the fuel cell 12, for example, to accommodate situations when the vehicle is operating under normal operating conditions (e.g., during cruise), when the vehicle is operating under low load conditions (e.g., during descent), or when the vehicle is operating under high load conditions (e.g., during take-off and climb). In some embodiments, when the fuel cell 12 is in the process of warming up to a desired operating temperature, the cooling system 10 may operate without transferring heat away from the fuel cell 12 until the desired operating temperature is reached.

The presently disclosed cooling system 10 will be described more fully hereinbelow with reference to the exemplary embodiment depicted in FIG. 1. The presently disclosed cooling system 10, however, is not limited to the arrangement shown in FIG. 1 and may be embodied in different forms. In addition, in the following description, the cooling system 10 is described with reference to use in an aircraft 2; however, the presently disclosed cooling system 10 is not limited to aircraft and may be used in a variety of different vehicle applications. The scope of the present disclosure is defined by the claims and their equivalents.

The cooling system 10 depicted in FIG. 1 includes a coolant circuit 14, a coolant header tank 16, a plenum 18, a liquid-to-air heat exchanger 20, a fuel cell heat exchanger 24 coupled to the fuel cell 12, a controller 26, and a working fluid reservoir 28 containing a volume of a working fluid 29. The coolant circuit 14 is in fluid communication with the coolant header tank 16 and defines a passageway for circulation of a coolant 30 from the coolant header tank 16, through the cooling system 10, and through the fuel cell heat exchanger 24. The coolant 30 is formulated to assist in the transfer of thermal energy between various components of the cooling system 10 and in the discharge of waste heat from the cooling system 10 to an ambient environment. The coolant 30 may comprise a heat transfer fluid having a high specific heat capacity and good thermal, chemical, electrical (e.g., not electrically conductive, dielectric), and mechanical compatibility with the other components of the cooling system 10.

In the embodiment depicted in FIG. 1, the coolant circuit 14 includes a coolant pump 32 and a temperature sensor 34. The coolant pump 32 is configured to circulate the coolant 30 through the coolant circuit 14. The temperature sensor 34 is configured to sense the temperature of the coolant 30 in the coolant circuit 14. As shown in FIG. 1, in some embodiments, the temperature sensor 34 may be positioned downstream of the fuel cell heat exchanger 24 and upstream of the liquid-to-air heat exchanger 20. In such an arrangement, the temperature sensor 34 may be configured to sense the temperature of the coolant 30 exiting the fuel cell heat exchanger 24 and to transmit a signal to the controller 26 indicative of the temperature of the coolant 30 at that specific location within the coolant circuit 14. In some embodiments, a temperature sensor (not shown) may be positioned upstream of the fuel cell heat exchanger 24 and downstream of the coolant header tank 16 and/or the coolant pump 32 in the passageway defined by the coolant circuit 14. In such case, the temperature sensor may be configured to sense the temperature of the coolant 30 prior to entering the fuel cell heat exchanger 24 and may be configured to transmit a signal to the controller 26 indicative of the temperature of the coolant 30 at that specific location within the passageway defined by the coolant circuit 14. In some embodiments, for example, when the fuel cell 12 is in the process of warming up to a desired operating temperature, coolant 30 flowing through the coolant circuit 14 may be directed to bypass the fuel cell heat exchanger 24. In such case, the cooling system 10 may operate without transferring heat away from the fuel cell 12 until the fuel cell 12 reaches a desired operating temperature.

The coolant header tank 16 contains a volume of the coolant 30 and may help accommodate thermal expansion of the coolant 30 and ensure positive pressure is maintained within the coolant circuit 14 during operation of the cooling system 10.

The plenum 18 includes an inlet 40 and an outlet 42 in fluid communication with an ambient environment outside the aircraft 2. The inlet 40 of the plenum 18 is configured to receive an airflow 44 of ambient air from the ambient environment and the outlet 42 is configured to discharge a processed airflow 46 from the plenum 18, for example, to the ambient environment. The airflow 44 introduced into the inlet 40 of the plenum 18 may be “ram air” and may be generated when the aircraft 2 is moving. The plenum 18 may be constructed and arranged to direct the airflow 44 through the aircraft 2 and through one or more components disposed within an airflow path through the plenum 18. As shown in FIG. 2, in some embodiments, the plenum 18 may be defined in the wing 6 of the aircraft 2. In other embodiments, the plenum 18 may be defined in the hull 8 of the aircraft 2 or in any other part of the aircraft 2, for example, in a nose of the aircraft 2.

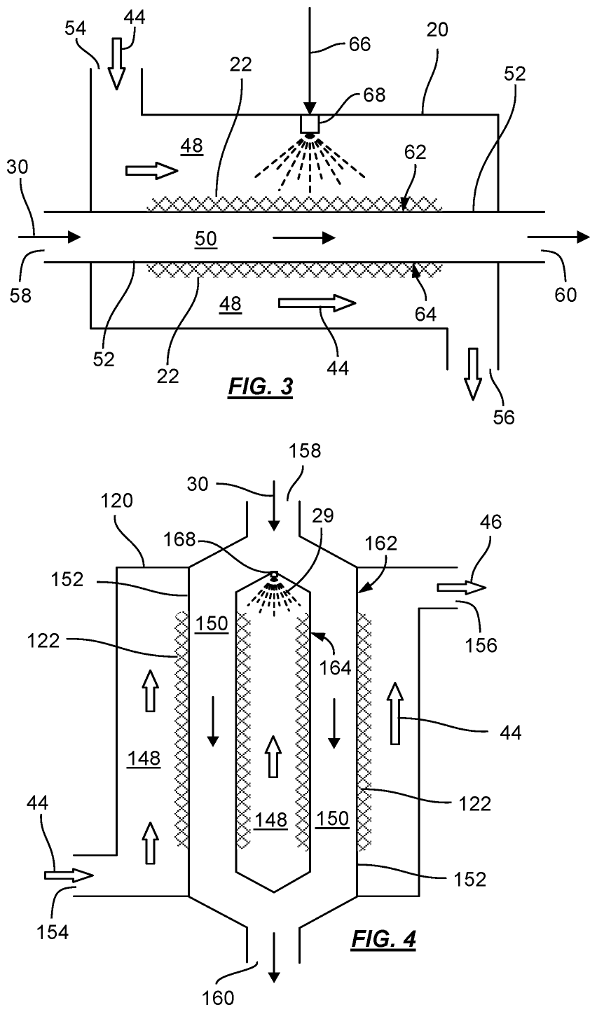

The liquid-to-air heat exchanger 20 is positioned in the airflow path defined between the inlet 40 and the outlet 42 of the plenum 18 and is configured to transfer thermal energy from the coolant 30 and to the airflow 44 flowing through the plenum 18 and through the liquid-to-air heat exchanger 20 during operation of the cooling system 10. As shown in FIG. 3, the liquid-to-air heat exchanger 20 defines an airflow channel 48 and a coolant channel 50 separated by a thermally conductive barrier 52 including a porous wick 22. The airflow channel 48 of the liquid-to-air heat exchanger 20 includes an airflow inlet 54 and an airflow outlet 56 in fluid communication with the inlet 40 and the outlet 42 of the plenum 18. In some embodiments, the airflow channel 48 of the liquid-to-air heat exchanger 20 may be in fluid communication with the inlet 40 and the outlet 42 of the plenum 18 but the liquid-to-air heat exchanger 20 may not be disposed directly within the plenum 18. The coolant channel 50 of the liquid-to-air heat exchanger 20 includes a coolant inlet 58 and a coolant outlet 60 in fluid communication with the aqueous coolant 30 circulating through the coolant circuit 14.

The thermally conductive barrier 52 is configured to provide a thermally conductive pathway for the indirect transfer of thermal energy between the airflow 44 flowing through the airflow channel 48 and the coolant 30 flowing through the coolant channel 50. As such, the thermally conductive barrier 52 is configured to prevent physical transfer between the airflow 44 flowing through the airflow channel 48 and the coolant 30 flowing through the coolant channel 50. In the liquid-to-air heat exchanger 20, heat may be transferred from the coolant 30 flowing through the coolant channel 50 to the thermally conductive barrier 52 by convection, heat may be transferred through the thermally conductive barrier 52 by conduction, and heat may be transferred from the thermally conductive barrier 52 to the airflow 44 flowing through the airflow channel 48 by convection. Heat may be transferred from the coolant 30 to the airflow 44 within the liquid-to-air heat exchanger 20 to help remove waste heat generated by the fuel cell 12 from the cooling system 10. During operation of the liquid-to-air heat exchanger 20, a temperature difference between the coolant 30 flowing through the coolant channel 50 and the airflow 44 flowing through the airflow channel 48 may drive sensible heat transfer between the coolant 30 and the airflow 44 via convection, conduction, or a combination thereof. When the coolant 30 exhibits a relatively high temperature, as compared to the temperature of the airflow 44, sensible heat transfer between the coolant 30 and the airflow 44 may increase the temperature of the airflow 44 and reduce the temperature of the coolant 30. The amount and rate of sensible heat transfer between the coolant 30 flowing through the coolant channel 52 and the airflow 44 flowing through the airflow channel 48 depends, at least in part, on the specific heat capacity of the airflow 44, the temperature difference between the coolant 30 and the airflow 44, and the mass flow rate of the airflow 44 flowing through the airflow channel 48.

In some embodiments, the liquid-to-air heat exchanger 20 may be in the form of a double pipe, shell and tube, plate, plate and shell, adiabatic shell, finned tube, or plate and fin heat exchanger. The flow direction of the coolant 30 in the coolant channel 50 may be parallel, opposite, or transverse to the flow direction of the airflow 44 in the airflow channel 48 of the liquid-to-air heat exchanger 20.

The thermally conductive barrier 52 includes a first side 62 and an opposite second side 64. The first side 62 of the thermally conductive barrier 52 at least partially defines the airflow channel 48 and the second side 64 of the thermally conductive barrier 52 at least partially defines the coolant channel 50. The porous wick 22 is disposed along the first side 62 of the thermally conductive barrier 52 and, in some embodiments, the porous wick 22 may be defined by the first side 62 of the thermally conductive barrier 52. The porous wick 22 defines an interconnected network of open pores through which the working fluid 29 can travel by capillary action. When the working fluid 29 is placed in direct contact with at least a portion of the interconnected network of open pores of the porous wick 22, the structure of the interconnected network of open pores of the porous wick 22 is configured to distribute the working fluid 29 substantially uniformly throughout the interconnected network of open pores of the porous wick 22. In some embodiments, the structure of the porous wick 22 may be defined by a porous open-celled structure, for example, by a porous open-celled metal foam. In some embodiments, the porous wick 22 may have a thickness in a range of 2 millimeters to 15 millimeters.

When the working fluid 29 is applied to the interconnected network of open pores of the porous wick 22, heat may be transferred from the coolant 30 flowing through the coolant channel 52, through the thermally conductive barrier 52, and to the airflow 44 flowing through the airflow channel 48. As the temperature of the working fluid 29 increases and approaches or reaches a phase change transition temperature (i.e., the boiling point of the working fluid 29) latent heat transfer may occur from the coolant 30 to the working fluid 29, with at least a portion of the working fluid 29 undergoing a change in phase from a liquid phase to a gas phase. Latent heat transfer from the coolant 30 to the working fluid 29 may decrease the temperature of the coolant 30 without increasing the temperature of the working fluid 29. The amount of latent heat that can be transferred from the coolant 30 to the working fluid 29 depends on the amount of energy required to change the state of the working fluid 29 from a liquid to a gas and on the mass of the working fluid 29 applied to the interconnected network of open pores of the porous wick 22. The amount of energy required to change the working fluid 29 from a liquid to a gas is known as the enthalpy of vaporization or the latent heat of vaporization of the working fluid 29. The mass of the working fluid 29 applied to the interconnected network of open pores of the porous wick 22 may be selected to compensate for the additional amount of waste heat generated by the fuel cell 12 during high load events, e.g., during take-off and climb.

The porous wick 22 may be configured to expose the working fluid 29 to the airflow 44 flowing through the airflow channel 48 and to promote evaporation of the working fluid 29 from the interconnected network of open pores into the airflow 44 flowing through the airflow channel 48. The thermal energy transferred from the coolant 30 to the working fluid 29 may be stored in the evaporated working fluid 29 in the form of latent heat and may be discharged from the airflow outlet 56 of the airflow channel 48 and from the aircraft 2 along with the processed airflow 46. When the working fluid 29 is not present in the interconnected network of open pores of the porous wick 22, sensible heat may continue to be transferred between the coolant 30 flowing through the coolant channel 50 and the airflow flowing through the airflow channel 48 by convection and/or conduction.

In situations where the aircraft 2 is operating under high load conditions, applying the working fluid 29 to the porous wick 22 may help remove thermal energy from the cooling system 10 and may increase the cooling rate of the coolant 30 flowing through the coolant channel 50, which may help compensate for circumstances in which the heat generation rate of the fuel cell 12 is relatively high, for example, which may occur when the aircraft 2 is operating under high load conditions. Applying the working fluid 29 to the porous wick 22 to evaporatively cool the coolant 30 when the aircraft 2 is operating under high load conditions may help maintain the coolant 30 at a desirable operating temperature within the cooling system 10 by removing excess waste heat therefrom and by discharging the waste heat from the cooling system 10 and from the aircraft 2 with the processed airflow 46. Using the working fluid 29 to evaporatively cool the coolant 30 may help remove excess waste heat from the cooling system 10 when the aircraft 2 is operating under high load conditions without increasing the volumetric flow rate of ambient air directed through the aircraft 2 (e.g., through the plenum 18), and thus without increasing the amount of drag experienced by the aircraft 2, which may increase the overall energy efficiency of the aircraft 2.

The mass of the working fluid 29 applied to the porous wick 22 may be selected to compensate for the increased waste heat generation rate of the fuel cell 12 when the aircraft 2 is operating under high load conditions by using the working fluid 29 to evaporatively cool the coolant 30 flowing through the coolant channel 50. The aircraft 2 may periodically operate under relatively high load conditions for certain established periods of time during certain types of events (e.g., during takeoff and climb). The waste heat generation rate of the fuel cell 12 may increase during such high load events by a known amount, as compared to the waste heat generation rate of the fuel cell 12 during relatively low load events (e.g., during cruise and/or descent). The overall amount of additional thermal energy generated by the fuel cell 12 during a single one of such high load events may be calculated based upon the duration of the event and the increase in the waste heat generation rate of the fuel cell 12. In some embodiments, the mass of the working fluid 29 applied to the porous wick 22 may be selected to remove an amount of thermal energy from the coolant 30 flowing through the coolant channel 50 that is greater than or equal to the amount of additional thermal energy generated by the fuel cell 12 during a single high load event.

The working fluid 29 may comprise a phase change material having a high latent heat of vaporization and the ability to undergo a phase change, i.e., from a liquid to a gas and vice versa, when subjected to certain temperature and pressure conditions generated within the liquid-to-air heat exchanger 20 of the cooling system 10. The working fluid 29 may be an aqueous or nonaqueous fluid. In some embodiments, the working fluid 29 may comprise or consist essentially of water. In some embodiments, the working fluid 29 may have the same composition as that of the coolant 30. In embodiments, the working fluid 29 may comprise one or more additives selected to impart certain desirable properties to the working fluid 29, e.g., a relatively high boiling point and/or freezing point. Examples of additives include ethylene glycol and/or propylene glycol.

As shown in FIG. 1, in some embodiments, the working fluid 29 may be introduced into the interconnected network of open pores of the porous wick 22 via a conduit 66 and the flow of the working fluid 29 to the porous wick 22 may be controlled or adjusted by a metering device 36. Operation of the metering device 36 may be controlled, for example, by the controller 26. For example, the controller 26 may be configured to control operation of the metering device 36 such that (i) working fluid 29 flows into the interconnected network of open pores of the porous wick 22 when the aircraft 2 is operating under high load conditions (e.g., during take-off and/or climb), and (ii) working fluid 29 is prevented from flowing into the interconnected network of open pores of the porous wick 22 when the aircraft 2 is operating under low load conditions (e.g., during cruise). In some embodiments, the controller 26 may control operation of the metering device 36 based upon information received from the temperature sensor 34. For example, if the temperature sensor 34 indicates that the temperature of the coolant 30 is below a defined temperature limit, the controller 26 may control operation of the metering device 36 so that working fluid 29 is prevented from flowing into the interconnected network of open pores of the porous wick 22. On the other hand, if the temperature sensor 34 indicates that the temperature of the coolant 30 is above a defined temperature limit, the controller 26 may control operation of the metering device 36 so that working fluid 29 flows into the interconnected network of open pores of the porous wick 22 and provides auxiliary evaporative cooling to the coolant 30 flowing through the coolant channel 50.

In some embodiments, the working fluid reservoir 28 may be in fluid communication with the porous wick 22, for example, via the conduit 66, and working fluid 29 may be supplied to the porous wick 22 from the working fluid reservoir 28. In such case, the metering device 36 may be configured to control or adjust the flow rate of the working fluid 29 from the working fluid reservoir 28 to the porous wick 22. As shown in FIGS. 1 and 3, in some embodiments, the conduit 66 and the working fluid reservoir 28 (or the coolant header tank 16) may be constructed and arranged such that the working fluid 29 may flow through the conduit 66 and into the interconnected network of open pores of the porous wick 22 via gravity. In other embodiments, the conduit 66 and the working fluid reservoir 28 (or the coolant header tank 16) may be constructed and arranged such that the working fluid 29 may flow through the conduit 66 and into the interconnected network of open pores of the porous wick 22 via capillary action.

In some embodiments, as shown in FIG. 3, the liquid-to-air heat exchanger 20 may include a nozzle 68 in fluid communication with the conduit 66. In such case, the working fluid 29 may be sprayed on to the porous wick 22 disposed on the first side 62 of the thermally conductive barrier 52 via the nozzle 68. In other embodiments, the nozzle 68 may be configured to spray droplets of the working fluid 29 into the airflow 44 flowing through the airflow channel 48 upstream of the porous wick 22.

In embodiments where the composition of the working fluid 29 is the same as that of the coolant 30, the metering device 36 and the conduit 62 may be in fluid communication with the coolant circuit 14. In such case, the metering device 36 may be configured to control the flow of coolant 30 to the porous wick 22 to provide auxiliary evaporative cooling to the coolant 30 via the liquid-to-air heat exchanger 20.

In some embodiments, the metering device 36 may comprise a control valve (not shown). In such case, the control valve may be moveable between an open position and a closed position. When the control valve is in the open position, working fluid 26 may flow through the conduit 62 may be introduced into the interconnected network of open pores of the porous wick 22. When the control valve is in the closed position, working fluid may be preventing from flowing through the conduit 62 and prevented from entering the interconnected network of open pores of the porous wick 22.

In some embodiments, the metering device 36 may comprise a pump (not shown). In such case, working fluid may be forced into the interconnected network of open pores of the porous wick 22 by the pump.

FIG. 4 depicts another embodiment of a liquid-to-air heat exchanger 120 that may be used in the cooling system 10. The liquid-to-air heat exchanger 120 is similar in many respects to the liquid-to-air heat exchanger 20 depicted in FIG. 3 and description of common subject matter generally may not be repeated here.

The liquid-to-air heat exchanger 120 is positioned in the airflow path defined between the inlet 40 and the outlet 42 of the plenum 18 and is configured to transfer thermal energy from the coolant 30 and to the airflow 44 flowing through the plenum 18 and through the liquid-to-air heat exchanger 120 during operation of the cooling system 10. As shown in FIG. 4, the liquid-to-air heat exchanger 120 defines multiple airflow channels 148 arranged in parallel to one another and multiple coolant channels 150 disposed between the airflow channels 148. Each of the coolant channels 150 is physically separated from an adjacent airflow channel 148 by a thermally conductive barrier 152 including a porous wick 122. The liquid-to-air heat exchanger 120 includes an airflow inlet 154 and an airflow outlet 156 in fluid communication with the inlet 40 and the outlet 42 of the plenum 18 and a coolant inlet 158 and a coolant outlet 160 in fluid communication with the coolant 30 circulating through the coolant circuit 14. The thermally conductive barriers 152 are configured to provide a thermally conductive pathway for the indirect transfer of thermal energy between the airflow 44 flowing through the airflow channels 148 and the coolant 30 flowing through the coolant channels 150. Each thermally conductive barrier 152 includes a first side 162 that at least partially defines one of the airflow channels 148 and an opposite second side 164 that at least partially defines one of the coolant channels 150. The porous wick 122 is disposed along the first side 162 of each of the thermally conductive barriers 152.

The liquid-to-air heat exchanger 120 depicted in FIG. 4 includes a nozzle 168 in fluid communication with the working fluid reservoir 28. In practice, the working fluid 29 may be sprayed on to the porous wick 122 disposed on the first side 162 of each of the thermally conductive barriers 152 via the nozzle 168. In the embodiment depicted in FIG. 4, the liquid-to-air heat exchanger 120 includes a single nozzle 168 that applies the working fluid 29 to the porous wick 122 is disposed along the first side 162 of each of the thermally conductive barriers 152. In some embodiments, multiple nozzles 168 may be used to effectively apply the working fluid 29 to the porous wick 122.

The fuel cell 12 includes an anode 70 and a cathode 72 separated by an ionically conductive electrolyte (not shown). The anode 70 is configured to receive a hydrogen-containing reactant gas 74 and to discharge a hydrogen-containing exhaust gas stream 76. The cathode 72 is configured to receive an oxygen-containing reactant gas 78 and to discharge a water vapor-containing exhaust gas stream 80. During operation of the fuel cell 12, hydrogen in the hydrogen-containing reactant gas 74 is oxidized at the anode 70, producing positively charged ions (e.g., hydrogen ions) and electrons. The positively charged hydrogen ions travel through the ionically conductive electrolyte from the anode 70 to the cathode 72, while the electrons simultaneously travel from the anode 70 to the cathode 72 outside the fuel cell 12 via an external circuit (not shown), which produces an electric current. The electric current generated during operation of the fuel cell 12 may be used to power the electric motor 4 onboard the aircraft 2. On the cathode 72 side of the fuel cell 12, The oxygen-containing reactant gas 78 is reduced by the electrons arriving from the external circuit and combined with the positively charged hydrogen ions to form water vapor, which is discharged from the fuel cell 12 in the form of the water vapor-containing exhaust gas stream 80. The reaction between oxygen and hydrogen at the cathode 72 is exothermic, which generates heat.

The fuel cell heat exchanger 24 is thermally coupled to the fuel cell 12 and is configured to transfer heat from the fuel cell 12 to the coolant 30 circulating through the coolant circuit 14 during operation of the cooling system 10 to help maintain the fuel cell 12 within a desired operating temperature range.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A cooling system for a fuel cell onboard a vehicle, the cooling system comprising:
a plenum including an inlet and an outlet in fluid communication with an ambient environment, wherein the inlet is configured to receive an airflow from the ambient environment;
a coolant circuit defining a coolant passageway, the coolant circuit being configured to circulate a coolant through the coolant passageway and through a portion of the fuel cell to transfer waste heat away from the fuel cell to the coolant; and
a liquid-to-air heat exchanger including a thermally conductive wall having a first side and an opposite second side, the first side of the thermally conductive wall at least partially defining an airflow channel in fluid communication with the inlet and the outlet of the plenum and the second side of the thermally conductive wall at least partially defining a coolant channel in fluid communication with the coolant passageway of the coolant circuit,
wherein the first side of the thermally conductive wall includes a porous wick defining an interconnected network of open pores and, when a working fluid is introduced into the interconnected network of open pores of the porous wick, the porous wick is configured to evaporatively cool the coolant flowing through the coolant channel by promoting evaporation of the working fluid from the interconnected network of open pores into the airflow flowing through the airflow channel.

2. The cooling system of claim 1, wherein, when a working fluid is not present in the interconnected network of open pores of the porous wick, the porous wick is configured to cool the coolant flowing through the coolant channel by promoting at least one of convective heat transfer and conductive heat transfer between the coolant flowing through the coolant channel and the airflow flowing through the airflow channel.

3. The cooling system of claim 1, wherein, when the porous wick is in direct contact with a working fluid, the porous wick is configured to distribute the working fluid throughout the interconnected network of open pores by capillary action.

4. The cooling system of claim 1, further comprising:
a metering device configured to control a flow of a working fluid to the porous wick.

5. The cooling system of claim 4, wherein the metering device comprises a control valve, the control valve being moveable between an open position and a closed position, wherein, when the control valve is in the open position, working fluid is introduced into the interconnected network of open pores of the porous wick, and, when the control valve is in the closed position, working fluid is preventing from entering the interconnected network of open pores of the porous wick.

6. The cooling system of claim 5, wherein, when the control valve is in the open position, working fluid flows into the interconnected network of open pores of the porous wick by gravity or by capillary action.

7. The cooling system of claim 4, wherein the metering device comprises a pump configured to introduce a working fluid into the interconnected network of open pores of the porous wick.

8. The cooling system of claim 4, wherein the working fluid is the same as the coolant, the metering device is in fluid communication with the coolant passageway of the coolant circuit, and wherein the metering device is configured to control a flow of the coolant to the porous wick.

9. The cooling system of claim 4, further comprising:
a working fluid reservoir in fluid communication with the metering device, wherein the metering device is configured to control a flow of a working fluid from the working fluid reservoir to the porous wick.

10. The cooling system of claim 4, further comprising:
a controller configured to control operation of the metering device such that (i) working fluid flows into the interconnected network of open pores of the porous wick when the vehicle is operating under high load conditions, and (ii) working fluid is prevented from flowing into the interconnected network of open pores of the porous wick when the vehicle is operating under low load conditions.

11. The cooling system of claim 10, further comprising:
a temperature sensor configured to sense a temperature of the coolant flowing through the coolant passageway of the coolant circuit and to communicate the temperature to the controller.

12. The cooling system of claim 1, further comprising:
a nozzle configured to spray a working fluid onto the porous wick or into the airflow flowing through the airflow channel upstream of the porous wick.

13. The cooling system of claim 1, wherein the liquid-to-air heat exchanger is disposed within the plenum.

14. The cooling system of claim 1, further comprising:
a working fluid in fluid communication with the porous wick, and wherein the working fluid comprises water.

15. The cooling system of claim 1, further comprising:
a third heat exchanger coupled to the fuel cell, the third heat exchanger being configured to transfer heat from the fuel cell to the coolant circulating through the coolant passageway of the coolant circuit.

16. The cooling system of claim 1, wherein the fuel cell comprises:
an anode configured to receive a hydrogen-containing reactant gas and to discharge a hydrogen-containing exhaust gas stream; and
a cathode configured to receive an oxygen-containing reactant gas and to discharge a water vapor-containing exhaust gas stream.

17. The cooling system of claim 1, wherein the inlet of the plenum is configured to receive the airflow from the ambient environment when the vehicle is moving.

18. The cooling system of claim 1, further comprising:
a coolant header tank in fluid communication with the coolant passageway of the coolant circuit.

19. The cooling system of claim 1, wherein the vehicle is an aircraft, and wherein the airflow comprises ram air.

20. The cooling system of claim 19, wherein the plenum is defined within a wing of the aircraft, and wherein the liquid-to-air heat exchanger is disposed within the plenum.
